(19) United States
(12) Patent Application Publication
(10) Pub. No.: US 2003/0062320 A1
(43) Pub. Date: Apr. 3, 2003

(54) Solar desalinazation plant comprising coated transparent formed bodies

(76) Inventors: Martin Dobler, Dusseldorf (DE); Peter Bier, Krefeld (DE); Gunther Stollwerck, Krefeld (DE)

Correspondence Address: BAYER CORPORATION, PATENT DEPARTMENT, 100 BAYER ROAD, PITTSBURGH, PA, 15205, US

(21) Appl. No.: 10/149,860

(22) PCT Filed: Dec. 5, 2000
(86) PCT No.: PCT/EP00/12196

(30) Foreign Application Priority Data
Dec. 15, 1999 (DE) 199 60 714.1

(51) Int. Cl. C02F 1/48

(52) U.S. Cl. 210/748

(57) ABSTRACT

The invention relates to the used of coated formed bodies, comprising a coating with wetting properties, for solar desalination plants. Said solar desalination plants comprise coated formed bodies, made from transparent thermoplastic plastics, which may be produced by coating a section of the formed body surface, or the total formed body surface, with a coating agent, comprising a) 0.005 to 2 parts by weight of a compound of formula (1), b) 1 to 20 parts by weight of a water insoluble oxide or several water insoluble oxides of a metal, or a semi-metal and c) 80 to 100 parts by weight of a mixture of an acid and water, which may comprise more than 90% water.

The present invention relates to the use of coated shaped articles with a water-spreading coating for solar desalination plants.

Solar desalination plants are of importance for the preparation of fresh water or drinking water from salt water or brackish water or for the distillative purification of contaminated water. Typical solar desalination plants have been described e.g. by Kumar and Tiwari (Energy (Oxford), 1996, 21(9), page 806).

Solar desalination plants comprise a tank with a transparent covering sheet facing the sun and a black base which absorbs sunlight as completely as possible. The tank is partly filled with salt water. When this plant is irradiated, the base and therefore the salt water heat up. The water vapour formed condenses on the transparent covering sheet as water of condensation and can be collected there. The efficiency can be improved further e.g. by multi-layer systems, by efficient insulation, by cooling the covering sheet and by preheating the salt water by a solar thermal plant. Instead of salt water, it is also possible to use waste water or brackish water.

Conventional solar desalination plants comprise a transparent glass sheet on which water condenses. On the basis of saving weight and better mechanical properties, such as, for example, resistance to breaking and resistance to hail, it would be desirable to use transparent thermoplastics, such as, for example, polycarbonate, as the covering sheet. However, as described e.g. by Ghoneyem and Ileri (Desalination 1997, 114(1), page 39), transparent thermoplastics in particular tend towards fogging during operation of such plants. The transparency of the sheets is thereby reduced, as a result of which the efficiency decreases sharply. Furthermore, such thermoplastics have a tendency for the water condensed there to form drops and drip back into the salt water initially introduced. The yield of fresh water is reduced as a result.

It would therefore be desirable to avoid fogging and the formation of drops by a suitable coating on the transparent thermoplastics. The aim would therefore be to discover a suitable water-spreading coating for solar desalination plants.

The term “water-spreading” is understood as meaning the property of a surface to form a wetting angle of less than 20 degrees with a drop of water applied thereto. A water-spreading coating is accordingly a coating which brings about this property of a surface.

Shaped articles with a water-spreading surface have the property that water which gets on to their surface does not draw together in drops separate from one another, but the drops spread out and on contact flow together to form a closed layer. A better light transparency of the transparent shaped article is achieved as a result. Furthermore, dripping of water from the underneath of the shaped article is made difficult. These so-called antidrop properties which inhibit the formation of drops are required in particular for various glazing materials of inorganic glasses (called glass for short in the following) or of thermoplastics. It is desirable there that the condensation water or precipitation water deposited thereon does not fall off in the form of drops but that, following the gradient of the material, it flows off at the lower edge in a closed layer or at least in cohesive tracks.

The water-repellent surface shows the opposite behaviour to a water-spreading surface. On water-repellent surfaces the water which gets on to such a surface draws together in to drops separate from one another.

Numerous attempts are known from the literature to provide water-repellent surfaces of plastics with water-spreading layers. According to DE-A 21 61 645, such coatings are produced from a copolymer of alkyl esters, hydroxyalkyl esters and quaternary aminoalkyl esters of acrylic or methacrylic acid and methylol ethers of methacrylamide as the crosslinking agent. They initially take up water, with swelling, and are converted gradually into a water-spreading state. Because of the swelling, however, the coating is soft and sensitive to mechanical damage.

To improve the mechanical strength of water-spreading coatings, inorganic constituents, such as colloidal metal oxides, in particular aluminium oxide, or colloidal silicon dioxide have been incorporated into the coating compositions (EP-A 7 681 877 or EP-A 7 606 193).

To achieve a higher mechanical resistance, coatings with hydrophilic inorganic constituents in a hydrophilic binder have been developed. According to JP-A 76 81 877, polyvinyl chloride films or polymethyl methacrylate films are covered with a coating of colloidal aluminium oxide as the hydrophilizing, hard constituent and polyvinyl alcohol and ammonium polyacrylate as binders. However, this coating is also sensitive to mechanical stresses in the water-swollen state.

Attempts have also already been made to incorporate wetting-friendly agents into the material of plastic itself from which the shaped article is produced. Thus, water-spreading coverings for greenhouses and similar humid rooms are produced according to DE-A 2 017 002 from a plastic which comprises surface-active agents, such as polyalkylene glycol. The water-spreading action of this additive is not sufficient. The resistance of the plastic to weathering is also impaired.

JP-A 76 06 193 proposes, as a glazing means, polymethacrylate sheets with a coating of 95 parts of colloidal silicon dioxide and 5 parts of a dispersion of a hydrophobic acrylic resin. However, the adhesion of this coating is completely unsatisfactory. This applies above all to the damp state.

A better adhesion of a water-spreading coating on shaped articles of plastic is achieved according to EP-A 51 405 with a covering built up from two layers, both layers comprising colloidal silicon dioxide, a partly hydrolysed polysiloxane and polyvinyl alcohol as the binder. The ratio of silicon to carbon is higher in the lower layer than in the outer layer.

Generalizing, it can be said that a coating with good water spreading can indeed usually be achieved with highly hydrophilic covering materials, but as a general rule the coating is too soft in the swollen state. If this disadvantage is to be counteracted by a higher degree of crosslinking or lower hydrophilicity, the water-spreading action decreases at the same time as the mechanical sensitivity. Silicon dioxide and various other oxides of metals or semi-metals indeed combine the advantages of high hardness and good wettability by water without swelling, but have the disadvantage that they do not adhere at all.

At the extent to which binders are used to anchor the oxides to the surface of the plastic, the wettability of the oxides and therefore the water-spreading action of the coating recedes, and the disadvantages of the binders emerge: mechanical sensitivity in the case of hydrophilic binders and inadequate water spreading in the case of hydrophobic binders.

DE-A 34 00 079 proposed bonding a water-spreading layer which substantially entirely comprises silicon dioxide or other metal oxides of colloidal particle size and itself has an inadequate adhesive strength on the layer of plastic to the water-repellent surface of a shaped article of plastic in a firmly adhering manner by means of an adhesion-promoting layer of an organic polymer which has polar groups and is insoluble in water and substantially not swellable in water.

The use of this adhesion-promoting layer or other so-called primer layers for better bonding of the water-spreading layer with the surface of the plastic necessitates an additional process step during the coating, as a result of which the production of coated shaped articles becomes more complicated and expensive.

All the coating compositions mentioned have the disadvantage that they must be applied from organic solvents.

The object of the present invention is to provide shaped articles for solar desalination which have a water-spreading coating, the coating having an excellent adhesive strength without an adhesion promoter layer, with a simultaneous high mechanical strength.

The object according to the invention is achieved by using shaped articles of transparent thermoplastics which are provided with a water-spreading coating for the production of solar desalination plants.

The object according to the invention is furthermore achieved by solar desalination plants comprising shaped articles of transparent thermoplastics which are provided with a water-spreading coating.

According to the invention, this object is achieved in particular by solar desalination plants comprising coated shaped articles of transparent thermoplastics obtainable by coating part of the surface of the shaped article or the entire surface of the shaped article with a coating composition comprising

A) 0.005 to 2 parts by weight of a compound represented by the general formula (1)

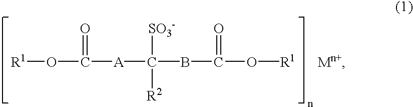

wherein

R¹ is a hydrocarbon radical having 1 to 30 C atoms,

R² is hydrogen or a hydrocarbon radical having 1 to 6 C atoms,

A is a single bond or a divalent hydrocarbon radical having 1 to 30 C atoms,

B is a single bond or a divalent hydrocarbon radical having 1 to 30 C atoms,

n is 1,2,3 or 4and

Mⁿ⁺ is a cation with n positive charges,

B) 1 to 20 parts by weight of a water-insoluble oxide or of several water-insoluble oxides of a metal or of a semi-metal,

C) 80 to 100 parts by weight of a mixture of an acid and water which comprises water to the extent of more than 90%,

with the proviso that the pH of the coating composition is less than 6.

The present invention thus also provides the use of the coated shaped articles described for the production of solar desalination plants.

The coated shaped articles according to the invention have an excellent adhesive strength of the coating with a simultaneous high mechanical strength. Adhesion promoter layers are not required. Another advantage of the shaped articles coated according to the invention is that the coating composition comprises predominantly water and therefore only small amounts of organic solvents. This results in economic and ecological advantages.

The compounds represented by the general formula (1), which are employed as component A of the coating composition according to the invention, are sulfo-dicarboxylic acid diesters. These are employed either as the free acid (i.e. n=1 and Mⁿ⁺=H⁺) or as salts. If the salts are employed, these can be the salts of any desired cations. Examples which may be mentioned are: elemental cations, organic or inorganic molecular cations or organic or inorganic complex cations. Mixtures of various cations can also be used.

Preferred compounds according to the general formula (1) are compounds represented by the general formula (2)

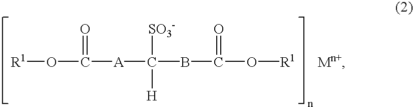

wherein

R¹ is an aliphatic hydrocarbon radical having 1 to 30 C atoms,

A is a single bond or a divalent aliphatic hydrocarbon radical having 1 to 3 C atoms,

B is a single bond or a divalent aliphatic hydrocarbon radical having 1 to 3 C atoms,

n is 1 or 2 and

Mⁿ⁺ is a cation with n positive charges.

Particularly preferred compounds according to the general formula (1) are compounds represented by the general formula (3)

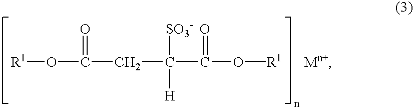

wherein

R¹ is an aliphatic hydrocarbon radical having 1 to 30 C atoms,

n is 1 or 2 and

Mⁿ⁺ is a cation with n positive charges.

Among these, the alkali metal salts or alkaline earth metal salts or mixtures thereof are preferred. Alkali metal salts are very particularly preferred. Sulfosuccinic acid bis-(2-ethylhexyl ester) sodium salt may be mentioned as an example.

The compounds represented by the general formula (1) can be prepared by the known process. Some of them are commercially obtainable.

The compounds represented by the general formula (1) can be employed for the preparation of the coating compositions as a pure substance or as a solution in any desired solvent or solvent mixture. They are preferably employed as a solution. For example, the commercial product Dapro®U99 from Daniel Products Company, Inc., New Jersey, USA can be employed. This is a solution of 40 g sulfosuccinic acid bis-(2-ethylhexyl ester) sodium salt in 43 g 2-butoxyethanol, 4 g ethanol, 3 g water and 10 g polyethylene glycol fatty acid ester (mixture based substantially on polyethylene glycol oleic acid ester, polyethylene glycol palmitic acid ester and polyethylene glycol stearic acid ester).

If the compound represented by the general formula (1) is employed as a solution for the preparation of the coating composition according to the invention, this means that the coating composition also comprises further substances, namely the solvents of the solution of A, beyond the three components A, B and C mentioned. The solution of the compound represented by the general formula (1) should preferably have a concentration of 5 to 95 wt. %, particularly preferably 10 to 90%, very particularly preferably 20 to 60%.

Oxides of elements of main group 3 or 4 or of sub-group 2, 3, 4, 5, 6, 7 or 8 of the periodic table of the elements are preferably employed as water-insoluble oxides according to the invention of a metal or of a semi-metal. Examples which may be mentioned are: aluminium oxide, silicon dioxide, titanium oxide, cerium oxide, zinc oxide, tin oxide, chromium oxide, indium oxide, zirconium oxide and iron oxide and pigments, in particular transparent pigments. The oxides according to the invention can comprise small amounts of other elements as doping agents.

Oxides of a metal or of a semi-metal of main group 3 or 4 of the periodic table of the elements are particularly preferably employed. Examples which may be mentioned are: aluminium oxide or silicon oxide.

Oxides of a metal or of a semi-metal from main group 4 of the periodic table of the elements are very particularly preferably employed. Among these, silicon dioxide is most preferred.

The oxides according to the invention of a metal or semi-metal are preferably used as a sol, i.e. as an aqueous colloidal solution, which preferably has a concentration of 10 to 50% by weight of the metal oxide and the particles of which on average have a diameter of preferably less than 5 μm.

The oxide particles are preferably present in the sol according to the invention in an average size of less than 200 nm, particularly preferably in the range from 5 to 100 nm. The particle size is determined by means of an ultracentrifuge.

The mixture according to the invention of an acid and water comprises water to the extent of more than 90%. It preferably comprises water to the extent of more than 95%, particularly preferably to the extent of more than 98%. It can comprise organic or inorganic acids. Weak acids are preferably used. Weak acids are those acids which have a pKₐ value of greater than 2. Aliphatic carboxylic acids are particularly preferably used. Acetic acid is very particularly preferably used.

The coating composition according to the invention comprises 0.005 to 2 parts by wt., preferably 0.01 to 0.5 part by wt., particularly preferably 0.05 to 0.4 part by wt. of component A.

The coating composition according to the invention comprises 1 to 20 parts by wt., preferably 2 to 20 parts by wt., particularly preferably 3 to 8 parts by wt. of component B.

The coating composition according to the invention has a pH of less than 6, preferably of less than 5.

The coating compositions according to the invention can optionally also comprise further components, such as e.g. surfactants and organic solvents for better wetting of the substrate and flow agents or defoamers.

The coating compositions according to the invention are preferably prepared by a procedure in which the sol of the oxide of a metal or semi-metal employed is prepared in water or a commercially available sol is diluted with water to the desired concentration in the coating composition according to the invention, a weakly acid pH is then advantageously established, for example by addition of acetic acid, and component A of the coating composition according to the invention is added in the amount envisaged for the coating compositions.

The coating composition and optionally also the sol of the oxide of a metal or of a semi-metal optionally employed are advantageously filtered, so that the particular composition comprises only particles with a particle diameter of preferably less than 5 μm.

The coating compositions according to the invention can be applied by all the known processes to the shaped articles to be coated, thus, for example, by brushing, pouring, rolling, spraying or any other known method. It is also possible to coat shaped articles by immersion in the aqueous coating compositions according to the invention, this procedure being particularly suitable for shaped articles with hollow spaces, such as e.g. double-walled sheets, since the shaped articles can also be coated on the inside in this manner.

To produce the water-spreading transparent coating on the shaped articles without an adhesion promoter layer, the coating composition according to the invention which has been applied is dried and stoved at elevated temperature, preferably at 90 to 155° C., particularly preferably at 110 to 135° C. The duration of this drying and stoving step depends on the amount of coating composition according to the invention which has been applied, and if necessary can be determined by the relevant expert by simple experiments.

The coating compositions according to the invention are preferably applied in amounts of 3 to 15 g/m², particularly preferably in amounts of 6 to 12 g/m², to the shaped articles to be coated. The thickness of the coating is preferably 0.1 to 0.5 μm, and is particularly preferably 0.2 to 0.4 μm. Coating of a shaped article of plastic with a coating composition according to the invention can be carried out after or already during production thereof.

The coating compositions according to the invention are suitable for coating any type of shaped articles. Shaped articles of thermoplastics are preferably used. These are preferably transparent thermoplastics. In particular, these are shaped articles of polymethyl methacrylate, polystyrene, polyvinyl chloride or polycarbonate, preferably of polycarbonate.

The shaped articles to be coated can have any desired shape. They preferably have the shape of a pane or a film or a sheet. The pane or the film or the sheet can be curved or flat. The shaped articles can also have a multi-layered structure, such as, for example, coextruded films or massive or multi-walled sheets, also with coextruded layers with a high content of additives, such as UV absorbers.

The shaped article can be coated over its entire surface or on only a part of its surface. Preferably, 20 to 100% of the surface of the shaped article is coated.

Thermoplastics which are suitable for coating are described, for example, in Becker/Braun, Kunststoff-Handbuch [Plastics Handbook], Carl Hanser Verlag, Munich, Vienna. Particularly suitable plastics are polycarbonates or copolycarbonates based on diphenols, the poly- or copolyacrylates and poly- or copolymethacrylates, such as, by way of example and preferably, polymethyl methacrylate, poly- or copolymers with styrene, such as, by way of example and preferably, transparent polystyrene or polystyrene/acrylonitrile (SAN), transparent thermoplastic polyurethanes, and polyolefins, such as, by way of example and preferably, transparent polypropylene types or polyolefins based on cyclic olefins (e.g. TOPAS®, Hoechst), poly- or copolycondensates of terephthalic acid, such as, by way of example and preferably, poly- or copolyethylene terephthalate (PET or CoPET), or glycol-modified PET (PETG).

The plastics can comprise additives.

According to the invention, in particular any polycarbonate can be coated.

Polycarbonates which are suitable according to the invention are both homopolycarbonates and copolycarbonate. A mixture of the polycarbonates suitable according to the invention can also be used.

The polycarbonates can be replaced in part or completely by aromatic polyester-carbonates.

The polycarbonates can also comprise polysiloxane blocks. The preparation thereof is described, for example, in U.S. Pat. Nos. 3,821,315, 3,189,662 and 3,832,419.

Preferred polycarbonates are those based on bisphenols of the general formula (4).

HO-Z-OH (4)

wherein Z is a divalent organic radical having 6 to 30 C atoms which contains one or more aromatic groups.

Examples of bisphenols according to the general formula (4) are bisphenols which belong to the following groups:

dihydroxydiphenyls,

bis-(hydroxyphenyl)-alkanes,

bis-(hydroxyphenyl)-cycloalkanes,

bis-(hydroxyphenyl)sulfides,

bis-(hydroxyphenyl)ethers,

bis-(hydroxyphenyl)ketones,

bis-hydroxyphenyl)sulfones,

bis-(hydroxyphenyl)-sulfoxides and

α,α′-bis-(hydroxyphenyl)-diisopropylbenzenes.

Derivatives of the bisphenols mentioned which are accessible, for example, by alkylation or halogenation on the aromatic rings of the bisphenols mentioned are examples of bisphenols according to the general formula (4).

Examples of bisphenols according to the general formula (4) are, in particular, the following compounds:

hydroquinone,

resorcinol,

4,4′-dihydroxydiphenyl,

bis-(3,5-dimethyl-4-hydroxyphenyl)-methane,

bis-(3,5-dimethyl-4-hydroxyphenyl)sulfone,

1,1-bis-(3,5-dimethyl-4-hydroxyphenyl)-p/m-diisopropylbenzene,

1,1-bis-(4-hydroxyphenyl)-1-phenyl-ethane,

1,1-bis-(3,5-dimethyl-4-hydroxyphenyl)-cyclohexane,

1,1-bis-(4-hydroxyphenyl)-3-methylcyclohexane,

1,1-bis-(4-hydroxyphenyl)-3,3-dimethylcyclohexane,

1,1-bis-(4-hydroxyphenyl)-4-methylcyclohexane,

1,1-bis-(4-hydroxyphenyl)-cyclohexane,

1,1-bis-(4-hydroxyphenyl)-3,3,5-trimethylcyclohexane,

2,2-bis-(3,5-dichloro-4-hydroxyphenyl)-propane,

2,2-bis-(3-methyl-4-hydroxyphenyl)-propane,

2,2-bis-(3,5-dimethyl-4-hydroxyphenyl)-propane,

2,2-bis-(4-hydroxyphenyl)-propane (i.e. bisphenol A),

2,2-bis-(3-chloro-4-hydroxyphenyl)-propane,

2,2-bis-(3,5-dibromo-4-hydroxyphenyl)-propane,

2,4-bis-(4-hydroxyphenyl)-2-methylbutane,

2,4-bis-(3,5-dimethyl-4-hydroxyphenyl)-2-methylbutane,

α,α′-bis-(4-hydroxyphenyl)-o-diisopropylbenzene,

α,α′-bis-(4-hydroxyphenyl)-m-diisopropylbenzene (i.e. bisphenol M) and

α,α′-bis-(4-hydroxyphenyl)-p-diisopropylbenzene.

Particularly preferred polycarbonates are the homopolycarbonate based on bisphenol A, the homopolycarbonate based on 1,1-bis-(4-hydroxyphenyl)-3,3,5-trimethylcyclohexane and the copolycarbonates based on bisphenol A and 1,1-bis-(4-hydroxyphenyl)-3,3,5-trimethylcyclohexane.

The bisphenols described according to the general formula (4) can be prepared by known processes, e.g. from the corresponding phenols and ketones.

Processes for the preparation of the bisphenols mentioned are described, for example, in the monograph H. Schnell, “Chemistry and Physics of Polycarbonates”, Polymer Reviews, volume 9, p. 77-98, Interscience Publishers, New York, London, Sidney, 1964 and in U.S. Pat. Nos. 3,028,635 in 3,062,781, in 2,999,835, in 3,148,172, in 2,991,273, in 3,271,367, in 4,982,014, in 2,999,846, in DE-A 1 570 703, in DE-A 2 063 050, in DE-A 2 036 052, in DE-A 2 211 956, in DE-A 3 832 396 and in FR-A 1 561 518, and in the Japanese Laid Open Specifications with the application numbers 62039/1986, 62040/1986 and 105550/1986.

The preparation of 1,1-bis-(4-hydroxyphenyl)-3,3,5-trimethylcyclohexane is described e.g. in U.S. Pat. No. 4,982,014.

Polycarbonates can be prepared by known processes. Suitable processes for the preparation of polycarbonates are, for example, the preparation from bisphenols with phosgene by the phase boundary process or from bisphenols with phosgene by the process in a homogeneous phase, the so-called pyridine process, or from bisphenols with carbonic acid esters by the melt transesterification process. These preparation processes are described e.g. in H. Schnell, “Chemistry and Physics of Polycarbonates”. Polymer Reviews, volume 9, p. 31-76, Interscience Publishers, New York, London, Sidney, 1964. The preparation processes mentioned are also described in D. Freitag, U. Grigo, P. R. Müller, H. Nouvertne, “Polycarbonates” in Encyclopedia of Polymer Science and Engineering, volume 11, second edition, 1988, pages 648 to 718 and in U. Grigo, K. Kirchner and P. R. Müller “Polycarbonate [Polycarbonates]” in Becker/Braun, Kunstoff-Handbuch [Plastics Handbook], volume 3/1, Polycarbonate, Polyacetale, Polyester, Celluloseester [Polycarbonates, Polyacetals, Polyesters, Cellulose Esters], Carl Hanser Verlag Munich, Vienna 1992, pages 117 to 299.

The melt transesterification process is described in particular in H. Schnell, “Chemistry and Physics of Polycarbonates”, Polymer Reviews, volume 9, p. 44-51, Interscience Publishers, New York, London, Sidney, 1964 and in DE-A 1 031 512, in U.S. Pat. Nos. 3,022,272, in 5,340,905 and in 5,399,659.

Carbonic acid diesters which can be employed for the preparation of polycarbonates by the melt transesterification process are, for example, diaryl esters of carbonic acid, the two aryl radicals preferably each having 6 to 14 C atoms. The diesters of carbonic acid based on phenol or alkyl-substituted phenols, that is to say, for example, diphenyl carbonate or dicresyl carbonate, are preferably employed.

The polycarbonates which are suitable according to the invention preferably have a weight-average molecular weight (\overline{M}_{w}), which can be determined e.g. by ultracentrifugation or scattered light measurement, of 10,000 to 200,000 g/mol. They particularly preferably have a weight-average molecular weight of 12,000 to 80,000 g/mol.

The average molecular weight of the polycarbonates according to the invention can be established, for example, in a known manner by a corresponding amount of chain terminators.

Suitable chain terminators are both monophenols and monocarboxylic acids. Suitable monophenols are e.g. phenol, p-chlorophenol, p-tert-butylphenol, cumylphenol or 2,4,6-tribromophenol, and long-chain alkylphenols, such as e.g. 4-(1,1,3,3-tetramethylbutyl)-phenol, or monoalkylphenols or dialkylphenols having a total of 8 to 20 C atoms in the alkyl substituents, such as e.g. 3,5-di-tert-butylphenol, p-tert-octylphenol, p-dodecylphenol, 2-(3,5-dimethyl-heptyl)-phenol or 4-(3,5-dimethyl-heptyl)-phenol. Suitable monocarboxylic acids are benzoic acid, alkylbenzoic acids and halogenobenzoic acids.

Preferred chain terminators are phenol, p-tert-butylphenol, 4-(1,1,3,3-tetramethylbutyl)-phenol and cumylphenol.

The amount of chain terminators is preferably between 0.5 and 10 mol %, based on the sum of the particular bisphenols employed.

The polycarbonates which are suitable according to the invention can be branched in a known manner, and in particular preferably by incorporation of branching agents which are trifunctional or more than trifunctional. Suitable branching agents are e.g. those with three or more than three phenolic groups or those with three or more than three carboxylic acid groups.

Suitable branching agents are, for example, phloroglucinol, 4,6-dimethyl-2,4,6-tri-(4-hydroxyphenyl)-hept-2-ene, 4,6-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxy-phenyl)-phenylmethane, 2,2-bis-[4,4-bis-(4-hydroxyphenyl)-cyclohexyl]-propane, 2,4-bis-(4-hydroxyphenyl-isopropyl)-phenol, 2,6-bis-(2-hydroxy-5′-methyl-benzyl)-4-methylphenol, 2-(4-hydroxyphenyl)-2-(2,4-dihydroxyphenyl)-propane, hexa-(4-(4-hydroxyphenyl-isopropyl)-phenyl)-terephthalic acid ester, tetra-(4-hydroxyphenyl)-methane, tetra-(4-(4-hydroxyphenyl-isopropyl)-phenoxy)-methane and 1,4-bis-(4′,4″-dihydroxytriphenyl)-methylbenzene, as well as 2,4-dihydroxybenzoic acid, trimesic acid, cyanuric chloride, 3,3-bis-(3-methyl-4hydroxyphenyl)-2-oxo-2,3-dihydroindole, trimesic acid trichloride and α,α,α″-tris-(4-hydroxyphenol)-1,3,5-triisopropylbenzene.

Preferred branching agents are 3,3-bis-(3-methyl-4-hydroxyphenyl)-2-oxo-2,3-dihydroindole and 1,1,1-tris-(4-hydroxyphenyl)-ethane.

The amount of branching agents optionally to be employed is preferably 0.05 mol % to 2 mol %, based on the moles of bisphenols employed.

In the case of preparation of the polycarbonate by the phase boundary process, for example, the branching agents can be initially introduced into the aqueous alkaline phase with the bisphenols and the chain terminators, or can be added as a solution in an organic solvent together with the carbonic acid derivatives. In the case of the transesterification process, the branching agents are preferably metered in together with the dihydroxyaromatics or bisphenols.

Conventional additives can be admixed to the polycarbonates according to the invention and/or applied to the surface of the shaped articles for modification of the properties. Conventional additives are, for example: fillers, reinforcing substances, stabilizers (for example UV stabilizers, heat stabilizers, gamma radiation stabilizers), antistatics, flow auxiliaries, mould release agents, fireproofing agents, dyestuffs and pigments. The additives mentioned and further suitable additives are described, for example, in Gächter, Müller, Kunststoff-Additive [Plastics Additives], 3rd edition, Hanser-Verlag, Munich, Vienna, 1989.

Other polymers can be admixed to the polycarbonates according to the invention, as a result of which so-called polymer blends are obtained. For example, blends can be prepared from the polycarbonates according to the invention and polyolefins, in particular ABS polymers.

The coated shaped articles according to the invention can also be used, in addition to the solar desalination use, e.g. as a glazing material or as a constituent of cars, greenhouses, swimming baths, stadia, railway stations, factory halls, roofing, walls, lamp covers, architectural glazing, light couplers, sights, spectacles, graphics, advertising boards, displays or packaging, or of panes for locomotion means of all types. A glazing material is to be understood as a material which can be employed in all instances where panes of conventional inorganic glasses have conventionally been employed or are still being employed.

The invention is explained in more detail below in the following examples.

Preparation of the Coating Compositions:

Coating Composition A

83.3 g of silica sol (Levasil® 300F from Bayer AG), which has been filtered through a 5 μm filter beforehand, are added to 416.7 g of completely desalinated water, while stirring. The aqueous suspension is then brought to a pH of 4.8 with 98% acetic acid, and 1.5 g Dapro® U99 (a solution of 40 g sulfosuccinic acid bis-(2-ethylhexyl ester) sodium salt in 43 g 2-butoxyethanol, 4 g ethanol, 3 g water and 10 g polyethylene glycol fatty acid ester (mixture based substantially on polyethylene glycol oleic acid ester, polyethylene glycol palmitic acid ester and polyethylene glycol stearic acid ester)) are added.

Levasil® 300F is an anionically stabilized silica sol from Bayer AG with an average particle size of 7 to 8 nm and a specific surface area of 300 m²/g. Levasil® 300F has a solids content of 30% by weight and a pH of approx. 9.8. It contains a small amount of <0.2 wt. % formaldehyde against attack by microorganisms.

Coating Composition B

The preparation is carried out analogously to coating composition A. Instead of Dapro® U99, however, 0.675 g sulfosuccinic acid bis-(2-ethylhexyl ester) sodium salt in 0.825 g 2-butoxyethanol is added.

Coating Composition C

The preparation is carried out analogously to coating composition A. Instead of the solution mentioned, however, 0.621 g sulfosuccinic acid bis-(2-ethylhexyl ester) sodium salt, 0.054 g polyethylene glycol (number-average of the molecular weight: 1,000) in 0.754 g 2-butoxyethanol and 0.0705 g ethanol are added.

Coating Composition D

The preparation is carried out analogously to coating composition C. Instead of the polyethylene glycol, 0.062 g polyethylene glycol fatty acid ester (mixture based substantially on polyethylene glycol oleic acid ester, polyethylene glycol palmitic acid ester and polyethylene glycol stearic acid ester) is added.

Coating of Polycarbonate Cellular Sheets

Cellular sheets of a branched aromatic polycarbonate (relative solution viscosity 1.315, measured on a solution of 0.5 g polycarbonate in 100 ml methylene chloride at room temperature), such as are used for greenhouse construction, were each coated on one side with coating compositions A to D by the flooding process and then dried at 130° C. for 0.5 h. The layer thicknesses were approx. 0.3 μm (thickness gauge ETA-SD-30, ETA-Optik; interference method). The coatings had no surface defects and showed no interference pattern. The wetting with water was uniform. The wetting angle of the water was below 1°.

Steam Test (100° C.)

The steam test was carried out as a further test. In this, the cellular sheets were exposed to a hot closed water vapour atmosphere at 100° C. When the water-spreading effect disappears and the first formation of drops takes place is observed.

Result:

| | | Life of the |
|---|---|---|
| | Coating | coating in the |
| | composition | steam test |
| Example | A | over 3 hours |
| Comparison | Copolyacrylate/ | 30 minutes |
| example | silica sol | |

In the case of the comparison example, a significant detachment of the coating with brownish discoloration of the water drops was to be observed after 30 minutes.

The cellular sheet of the example according to the invention was furthermore tilted out of the horizontal at various angles. At an angle of inclination of 5° or more, condensed water flows off the sides on the underneath without dripping.

Model Greenhouse Test

The coated polycarbonate cellular sheets were fixed at an angle of 60°, with the coated side underneath, on the roof of a model greenhouse so that the water-spreading action could be compared by observing the formation of droplets. Water was evaporated in the model greenhouse by means of a heat source, so that a temperature of 50° C. and an atmospheric humidity of 100% was established.

The sheets were left under these conditions for 6 h and then heated at 40° C. in a dry heating cabinet for 4 h. The procedure in the model greenhouse and in the heating cabinet was then repeated in constant alternation until the water-spreading effect disappeared (which can be seen from the formation of drops on the sheet).

Three commercially obtainable polycarbonate cellular sheets with a water-spreading coating, such as are used for greenhouse construction, were tested at the same time for comparison.

Result:

| | | Life of the coating |
|---|---|---|
| | Coating | (in cycles) |
| Example 1 | A | >80 |
| Example 2 | B | >80 |
| Example 3 | C | >80 |
| Example 4 | D | >80 |
| Comparison | Copolyacrylate/ | >80 |
| example 5 | silica sol | |
| Comparison | Polyvinylpyrrolidone/ | 15 |
| example 6 | silica sol | |
| Comparison | Surfactant/ | 15 |
| example 7 | silica sol | |

1. Use of shaped articles of thermoplastics, which are provided with a water-spreading coating for the production of solar desalination plants.

2. Solar desalination plants comprising shaped articles of transparent thermoplastics, which are provided with a water-spreading coating.

3. Solar desalination plants comprising sheets of transparent thermoplastics, which are provided with a water-spreading coating.

4. Solar desalination plants comprising coated shaped articles of transparent thermoplastics, obtainable by coating part of the surface of the shaped article or the entire surface of the shaped article with a coating composition comprising
A) 0.005 to 2 parts by weight of a compound represented by the general formula (1) 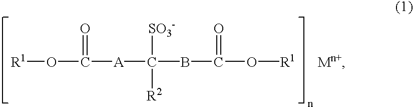
wherein
R¹ is a hydrocarbon radical having 1 to 30 C atoms,
R² is hydrogen or a hydrocarbon radical having 1 to 6 C atoms,
A is a single bond or a divalent hydrocarbon radical having 1 to 30 C atoms,
B is a single bond or a divalent hydrocarbon radical having 1 to 30 C atoms,
n is 1,2,3 or 4and
Mⁿ⁺ is a cation with n positive charges,
B) 1 to 20 parts by weight of a water-insoluble oxide or of several water-insoluble oxides of a metal or of a semi-metal,
C) 80 to 100 parts by weight of a mixture of an acid and water which comprises water to the extent of more than 90%,
with the proviso that the pH of the coating composition is less than 6.

5. Use of shaped articles of transparent thermoplastics, obtainable by coating part of the surface of the shaped article or the entire surface of the shaped article with a coating composition comprising
A) 0.005 to 2 parts by weight of a compound represented by the general formula (1) 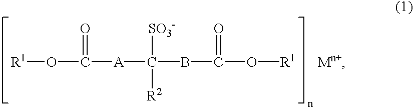
wherein
R¹ is a hydrocarbon radical having 1 to 30 C atoms,
R² is hydrogen or a hydrocarbon radical having 1 to 6 C atoms,
A is a single bond or a divalent hydrocarbon radical having 1 to 30 C atoms,
B is a single bond or a divalent hydrocarbon radical having 1 to 30 C atoms,
n is 1,2,3 or 4and
Mⁿ⁺ is a cation with n positive charges,
B) 1 to 20 parts by weight of a water-insoluble oxide or of several water-insoluble oxides of a metal or of a semi-metal,
C) 80 to 100 parts by weight of a mixture of an acid and water which comprises water to the extent of more than 90%,
with the proviso that the pH of the coating composition is less than 6, for the production of solar desalination plants.
